(19) United States
(12) Patent Application Publication
(10) Pub. No.: US 2025/0004621 A1
(43) Pub. Date: Jan. 2, 2025

(54) INFORMATION PROCESSING APPARATUS, CONTROL METHOD, AND NON-TRANSITORY COMPUTER READABLE MEDIUM

(71) Applicant: Yokogawa Electric Corporation, Tokyo (JP)

(72) Inventor: Mayu Tsuyuki, Tokyo (JP)

(73) Assignee: Yokogawa Electric Corporation, Tokyo (JP)

(21) Appl. No.: 18/672,652

(22) Filed: May 23, 2024

(30) Foreign Application Priority Data
Jun. 30, 2023 (JP) 2023-108039

(51) Int. Cl. G06F 3/04842; G06F 3/04883

(52) U.S. Cl. CPC G06F 3/04842; G06F 3/04883

(57) ABSTRACT

It would be helpful to improve user interface technology for numerical input on touch screens. An information processing apparatus includes a touch screen and a controller. The controller is configured to detect a touch operation within a predetermined area on the touch screen, upon detecting the touch operation, emphasize the display of a predetermined digit, as a target digit, of a numeral value displayed in a numerical object, and determine the direction of swipe input after the touch operation and, in response to the direction, change the numerical value with respect to the target digit or change the target digit.

### CROSS-REFERENCE TO RELATED APPLICATION

This application claims priority to Japanese Patent Application No. 2023-108039, filed on Jun. 30, 2023, the entire contents of which are incorporated herein by reference.

### TECHNICAL FIELD

The present disclosure relates to an information processing apparatus, a control method, and a non-transitory computer readable medium.

### BACKGROUND

In conventional control apparatuses such as industrial measurement instruments, numerical values are input using hard keys such as numeric keypads. However, in industrial measurement instruments and the like in recent years, numerical input has shifted to the use of touch screens that allow direct manipulation of displays. For example, Patent Literature (PTL) 1 discloses technology for operation input using a touch screen. For example, numerical input can be performed by displaying, on the touch screen, a numeric keypad or the like for the numerical input.

### CITATION LIST

### Patent Literature

PTL 1: JP 2016-062421 A

### SUMMARY

An information processing apparatus according to an embodiment of the present disclosure is an information processing apparatus including:
a touch screen; and
a controller configured to:
   detect a touch operation within a predetermined area on the touch screen;
   upon detecting the touch operation, emphasize the display of a predetermined digit, as a target digit, of a numeral value displayed in a numerical object; and
   determine the direction of swipe input after the touch operation and, in response to the direction, change the numerical value with respect to the target digit or change the target digit.

### BRIEF DESCRIPTION OF THE DRAWINGS

In the accompanying drawings:

FIG. 1 is a block diagram illustrating a schematic configuration of an information processing apparatus according to an embodiment of the present disclosure;

FIG. 2 is an example of screen display when a user interface includes a plurality of numerical objects;

FIG. 3 is a flowchart illustrating operations of the information processing apparatus according to an embodiment of the present disclosure;

FIG. 4 is a diagram illustrating an example of screen transition displayed in accordance with the operations of the information processing apparatus according to the embodiment;

FIG. 5 is a diagram illustrating an example of screen transition displayed in accordance with the operations of the information processing apparatus according to the embodiment;

FIG. 6 is a diagram illustrating an example of screen transition displayed in accordance with the operations of the information processing apparatus according to the embodiment;

FIG. 7 is a diagram illustrating an overview of Variant 1 of the embodiment; and

FIG. 8 is a diagram illustrating an overview of Variant 2 of the embodiment.

### DETAILED DESCRIPTION

As described above, in the technology of PTL 1, numerical input can be performed by displaying, on a touch screen, a numeric keypad or the like for the numerical input. However, displaying the numeric keypad for the numerical input on the touch screen requires a certain degree of display area, which may cause difficulty in efficient numerical operation on a small screen. In other words, there is room for improvement in user interface technology for numerical input on touch screens.

It would be helpful to improve user interface technology for numerical input on touch screens.
(1) An information processing apparatus according to an embodiment of the present disclosure is an information processing apparatus including:
   a touch screen; and
   a controller configured to:
      detect a touch operation within a predetermined area on the touch screen;
      upon detecting the touch operation, emphasize the display of a predetermined digit, as a target digit, of a numeral value displayed in a numerical object; and
      determine the direction of swipe input after the touch operation and, in response to the direction, change the numerical value with respect to the target digit or change the target digit.
(2) An information processing apparatus according to an embodiment of the present disclosure is the information processing apparatus according to (1), wherein the controller is configured to:
   increase the numerical value with respect to the target digit when the direction is an upward direction,
   decrease the numerical value with respect to the target digit when the direction is a downward direction,
   change the target digit to the adjacent digit to the left when the direction is a leftward direction, and
   change the target digit to the adjacent digit to the right when the direction is a rightward direction.
(3) An information processing apparatus according to an embodiment of the present disclosure is the information processing apparatus according to (1) or (2), wherein the emphasized display is an underline.
(4) An information processing apparatus according to an embodiment of the present disclosure is the information processing apparatus according to any one of (1) to (3), wherein the emphasized display is inverted display.
(5) An information processing apparatus according to an embodiment of the present disclosure is the information processing apparatus according to (2), wherein the controller is further configured to:
when the touch operation has continued for a predetermined time at an upper end portion of the touch screen, increase the numerical value with respect to the target digit, based on a touch duration at the upper end portion after a lapse of the predetermined time, and
when the touch operation has continued for the predetermined time at a lower end portion of the touch screen, decrease the numerical value with respect to the target digit, based on a touch duration at the lower end portion after a lapse of the predetermined time.
(6) An information processing apparatus according to an embodiment of the present disclosure is the information processing apparatus according to (2) or (5), wherein the controller is further configured to:
when the touch operation has continued for a predetermined time at a left end portion of the touch screen, change the target digit to the adjacent digit to the left, based on a touch duration at the left end portion after a lapse of the predetermined time, and
when the touch operation has continued for the predetermined time at a right end portion of the touch screen, change the target digit to the adjacent digit to the right, based on a touch duration at the right end portion after a lapse of the predetermined time.
(7) An information processing apparatus according to an embodiment of the present disclosure is the information processing apparatus according to any one of (1) to (6), wherein the controller is further configured to display a pop-up window corresponding to the numerical value.
(8) An information processing apparatus according to an embodiment of the present disclosure is the information processing apparatus according to (7), wherein the pop-up window is displayed translucently.
(9) A method according to an embodiment of the present disclosure is a method performed by an information processing apparatus including a touch screen, the method including:
detecting a touch operation within a predetermined area on the touch screen;
upon detecting the touch operation, emphasizing the display of a predetermined digit, as a target digit, of a numeral value displayed in a numerical object; and
determining the direction of swipe input after the touch operation and, in response to the direction, changing the numerical value with respect to the target digit or changing the target digit.
(10) A program according to an embodiment of the present disclosure is configured to cause a computer, which includes a touch screen and functions as an information processing apparatus, to execute operations, the operations including:
detecting a touch operation within a predetermined area on the touch screen;
upon detecting the touch operation, emphasizing the display of a predetermined digit, as a target digit, of a numeral value displayed in a numerical object; and
determining the direction of swipe input after the touch operation and, in response to the direction, changing the numerical value with respect to the target digit or changing the target digit.

According to an embodiment of the present disclosure, it is possible to improve user interface technology for numerical input on touch screens.

An information processing apparatus 10 according to an embodiment of the present disclosure will be described below with reference to the drawings.

In the drawings, identical or equivalent portions are denoted by the same reference numerals. In the description of this embodiment, explanations of the identical or equivalent portions are omitted or simplified as appropriate.

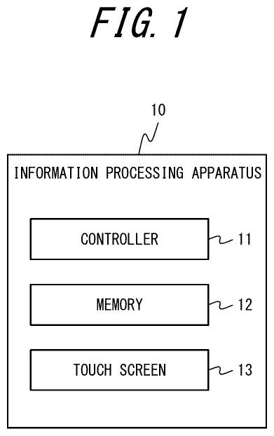

With reference to FIG. 1, an overview and configuration of the information processing apparatus 10 according to this embodiment will be described.

The information processing apparatus 10 is any information processing apparatus used by a user. For example, the information processing apparatus includes industrial measurement instruments, control apparatuses, general purpose electronic equipment, dedicated electronic equipment, or the like. The information processing apparatus 10 accepts, on a touch screen, numerical input for laser output, power output, or the like, for example.

An overview of this embodiment will be described first, and the details thereof will be described below. The information processing apparatus 10 detects a touch operation within a predetermined area on the touch screen. Upon detecting the touch operation, the information processing apparatus 10 emphasizes the display of a predetermined digit, as a target digit, of a numerical value displayed in a numerical object. The information processing apparatus 10 then determines the direction of swipe input after the touch operation and, in response to the direction of the swipe input, changes the numerical value with respect to the target digit or changes the target digit.

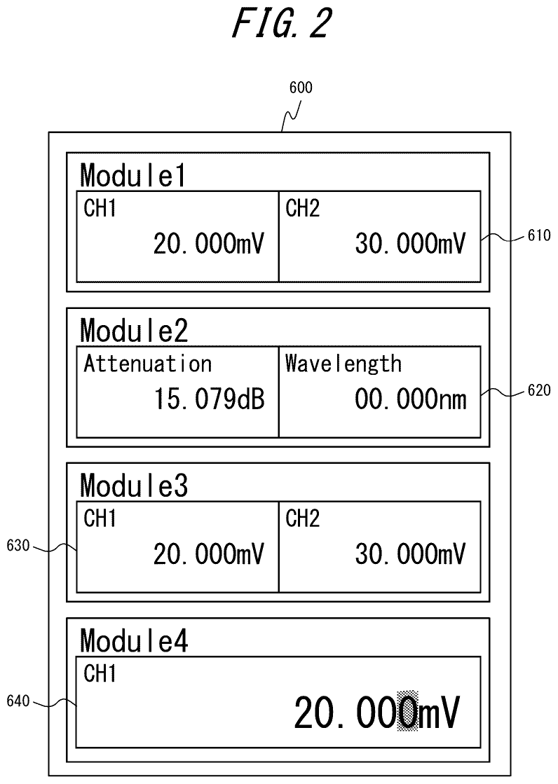

Thus, according to this embodiment, the information processing apparatus 10 determines the direction of the swipe input and, in response to the direction of the swipe input, changes the numerical value with respect to the target digit or changes the target digit. Therefore, the information processing apparatus 10 according to this embodiment can improve user interface technology for numerical input on touch screens in that the information processing apparatus 10 can accept numerical input without using a numeric keypad or the like for the numerical input. The technology of this embodiment is particularly useful when a plurality of numerical objects to be operated is displayed on a screen. A screen 600 illustrated in FIG. 2 includes a numerical object 610, a numerical object 620, a numerical object 630, and a numerical object 640. In this case, according to this embodiment, numerical values can be input only by swipe input without using a numeric keypad or the like. For example, the user can change a numerical value of a specific numerical object (e.g., the numerical object 640) by swipe input while checking numerical values set for each of Modules 1, 2, 3, and 4, and the like.

Next, each configuration of the information processing apparatus 10 will be described in detail.

### (Configuration of Information Processing Apparatus 10)

As illustrated in FIG. 1, the information processing apparatus 10 is provided with a controller 11, a memory 12, and a touch screen 13.

The controller 11 includes at least one processor, at least one dedicated circuit, or a combination of these. The processor is a general purpose processor such as a central processing unit (CPU) or graphics processing unit (GPU), or a dedicated processor specialized for particular processing. The dedicated circuit is, for example, a field-programmable gate array (FPGA) or an application specific integrated circuit (ASIC). The controller 11 executes processing related to operations of the information processing apparatus 10 while controlling each part of the information processing apparatus 10.

The memory 12 includes at least one semiconductor memory, at least one magnetic memory, at least one optical memory, or a combination of at least two of these. The semiconductor memory is, for example, random access memory (RAM) or read only memory (ROM). The RAM is, for example, static random access memory (SRAM) or dynamic random access memory (DRAM). The ROM is, for example, electrically erasable programmable read only memory (EEPROM). The memory 12 functions as, for example, a main memory, an auxiliary memory, or a cache memory. The memory 12 stores data to be used in the operations of the information processing apparatus 10 and data obtained by the operations of the information processing apparatus 10.

The touch screen 13 is an input/output section provided integrally with a display. The display may be, for example, a liquid crystal display (LCD) or an organic electro luminescence (EL) display. The touch screen 13 accepts operations to input data to be used in the operations of the information processing apparatus 10. The touch screen 13 also displays and outputs data obtained by the operations of the information processing apparatus 10. The touch screen 13 may be connected to the information processing apparatus 10 as an external input device, instead of being provided in the information processing apparatus 10. As a connection method, for example, any connection method such as universal serial bus (USB), high-definition multimedia interface (HDMI®) (HDMI is a registered trademark in Japan, other countries, or both), or Bluetooth® (Bluetooth is a registered trademark in Japan, other countries, or both) may be used.

The functions of the information processing apparatus 10 are realized by executing a program according to this embodiment by a processor corresponding to the information processing apparatus 10. In other words, the functions of the information processing apparatus 10 are realized by software. The program causes a computer to function as the information processing apparatus 10 by causing the computer to execute the operations of the information processing apparatus 10. In other words, the computer functions as the information processing apparatus 10 by executing the operations of the information processing apparatus 10 according to the program.

In this embodiment, the program can be recorded in a computer readable recording medium. The computer readable recording medium includes a non-transitory computer readable medium, and is, for example, a magnetic recording device, an optical disk, a magneto-optical recording medium, or a semiconductor memory. The program is distributed, for example, by selling, transferring, or lending a portable recording medium such as a digital versatile disc (DVD) or compact disc read only memory (CD-ROM) in which the program is recorded. The program may also be distributed by storing the program in storage on an external server and transmitting the program from the external server to other computers. The program may also be provided as a program product.

### (Operations of Information Processing Apparatus)

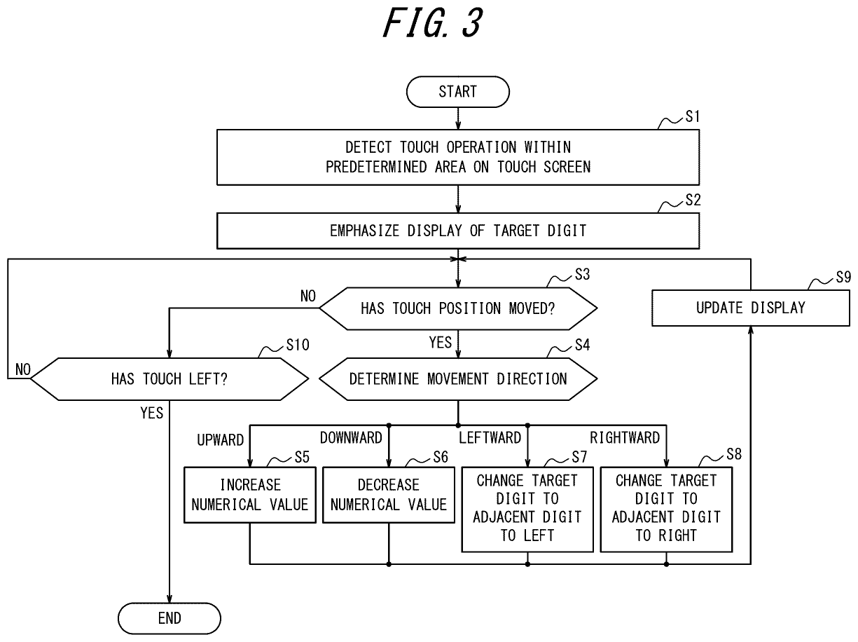

With reference to FIG. 3, the operations of the information processing apparatus 10 according to this embodiment will be described. FIG. 3 is a flowchart illustrating an example of a method executed by the information processing apparatus 10 according to this embodiment.

Step S1: The controller 11 of the information processing apparatus 10 detects a touch operation within a predetermined area on the touch screen 13. In other words, the controller 11 detects at which position on the touch screen 13 the touch operation is performed by the user.

The predetermined area may be, for example, an area that coincides with a display area of a numerical object. Alternatively, the predetermined area may be different from the display area of the numerical object. For example, when the user cannot see the touch screen 13 from the front, the predetermined area may be changed according to the user's viewing position. For example, when the user's viewing position of the touch screen 13 is above the front of the touch screen 13, the predetermined area may be at a position to which the display area of the numerical object is shifted upward in parallel by a predetermined distance.

Step S2: Upon detecting the touch operation in step S1, the controller 11 emphasizes the display of a predetermined digit, as a target digit, of a numerical value displayed in the numerical object. The predetermined digit (initial target digit) of the numerical value may be set arbitrarily. For example, the predetermined digit may be the smallest digit (rightmost digit). Alternatively, the predetermined digit may be the smallest digit of the integer portion.

Any method can be adopted to emphasize the display. For example, the controller 11 may emphasize the display of the predetermined digit, as the target digit, of the numerical value by inverting the color of only the target digit. Alternatively, the controller 11 may emphasize the display of the predetermined digit, as the target digit, of the numerical value by changing the font of only the target digit to bold. The aspects of the emphasized display are not limited to these, and the display may be emphasized by adding an underline or other means.

Step S3: The controller 11 determines whether a touch position has moved. In other words, the controller 11 determines whether there is swipe input after the touch operation. The controller 11 determines whether there is a movement of the touch position by comparing a change in the touch position (touch movement distance) with a predetermined threshold. The predetermined threshold is, for example, 5 mm, but is not limited to this. When the change in the touch position is equal to or more than the predetermined threshold, the process proceeds to step S4. In other words, when the length of the swipe input is equal to or more than the predetermined threshold, the process proceeds to step S4. In this embodiment, the presence of the swipe input is determined based on the movement of the touch position after the touch operation in step S1. In other words, the touch in step S1 and the swipe input in step S3 are operations in which the touch to the touch screen 13 is continued. In other words, in this embodiment, from step S1 to step S3, the user's finger or the like has not left the touch screen 13, and the touch continues. The predetermined threshold may be set differently depending on the direction of the swipe. For example, the predetermined threshold may be 8 mm in a horizontal direction, and the predetermined threshold may be 5 mm in a vertical direction.

Step S4: The controller 11 determines the direction of the swipe input determined in step S3. When the direction of the swipe input is an upward direction, the process proceeds to step S5. When the direction of the swipe input is a downward direction, the process proceeds to step S6. When the direction of the swipe input is a leftward direction, the process proceeds to step S7. When the direction of the swipe input is a rightward direction, the process proceeds to step S8.

Step S5: When the direction of the swipe input is the upward direction, the controller 11 increases the numerical value with respect to the target digit. Specifically, the numerical value of the target digit is increased by 1. The process then proceeds to step S9. When the increase in the numerical value of the target digit by 1 has an influence on one or more digits other than the target digit, the controller 11 changes numerical values of the digits other than the target digit as well.

Step S6: When the direction of the swipe input is the downward direction, the controller 11 decreases the numerical value with respect to the target digit. Specifically, the numerical value of the target digit is decreased by 1. The process then proceeds to step S9. When the decrease in the numerical value of the target digit by 1 has an influence on one or more digits other than the target digit, the controller 11 changes numerical values of the digits other than the target digit as well.

Step S7: When the direction of the swipe input is the leftward direction, the controller 11 changes the target digit to the adjacent digit to the left. When the target digit before the change is the most significant digit, no operation is performed. The process then proceeds to step S9.

Step S8: When the direction of the swipe input is the rightward direction, the controller 11 changes the target digit to the adjacent digit to the right. When the target digit before the change is the least significant digit, no operation is performed. The process then proceeds to step S9.

Step S9: According to the change made in step S5, step S6, step S7, or step S8, the controller 11 updates the display content of the numerical object or the target digit whose display is to be emphasized, and displays the updated numerical object on the touch screen 13. The process then returns to step S3.

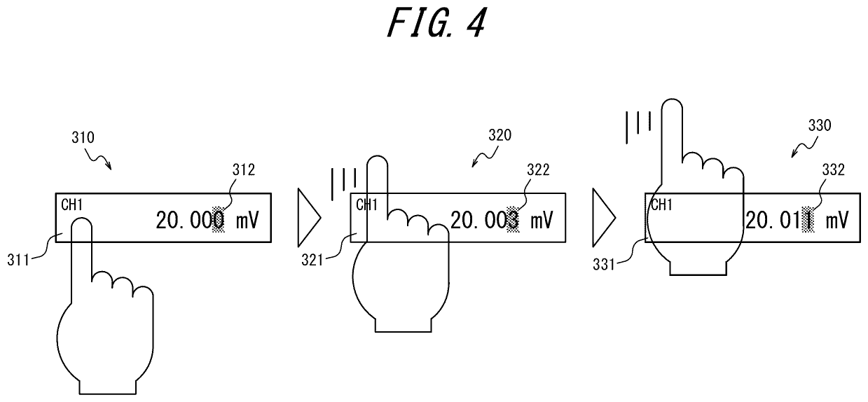

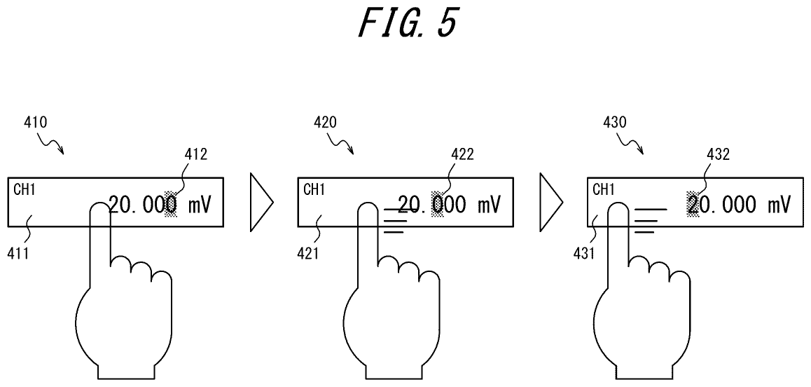

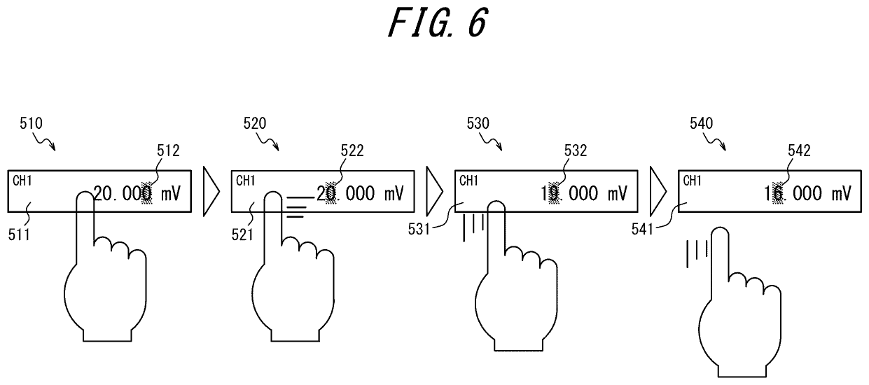

With reference to FIG. 4, an example of the updated display when the direction of the swipe input is the upward direction is illustrated. Here, a screen is updated in the order of a screen 310, a screen 320, and a screen 330, and displayed on the touch screen 13. In the screen 310, a touch operation within a predetermined area pertaining to a numerical object 311 is detected, and the display of a target digit 312 in the numerical object 311 is emphasized. FIG. 4, as well as FIGS. 5 and 6 below, discloses an example in which the predetermined area, which accepts the user's input, is different from the display area of the numerical object. This makes it easier for the user to perform operation while seeing the numerical value.

Next, in the screen 320, swipe input is determined to be in the upward direction, and a numerical value is increasing with respect to a target digit 322 in a numerical object 321. Specifically, the voltage of CH1 is increasing from 20.000 mv, which is a value in the screen 310, to 20.003 mv. Note that here, the swipe input of a predetermined threshold length has been determined three times in succession. Thereby, the numerical value of the target digit has been added by 1 three times. The transition from the screen 310 to the screen 320 is made through this process. In other words, in the transition from the screen 310 to the screen 320, the operations in step S3, step S4, step S5, and step S9 described above have been performed three times.

Next, in the screen 330, swipe input is further determined to be in the upward direction, and the numerical value is increasing with respect to a target digit 332 in a numerical object 331. Specifically, the voltage of CH1 is increasing from 20.003 mv, which is the value in the screen 320, to 20.011 mv. Note that here, the swipe input of the predetermined threshold length or more has been determined eight times in succession. Thereby, the numerical value of the target digit has been increased by 1 eight times. The transition from the screen 320 to the screen 330 is made through this process. In other words, in the transition from the screen 320 to the screen 330, the operations in step S3, step S4, step S5, and step S9 described above have been performed eight times.

With reference to FIG. 5, an example of the updated display when the direction of the swipe input is the leftward direction is illustrated. Here, a screen is updated in the order of a screen 410, a screen 420, and a screen 430 and displayed on the touch screen 13. In the screen 410, a touch operation within a predetermined area pertaining to a numerical object 411 is detected, and the display of a target digit 412 in the numerical object 411 is emphasized.

Next, in the screen 420, swipe input is determined to be in the leftward direction, and the digit to be operated is changed to a target digit 422. Specifically, the target digit is changed from the third decimal place, which is the smallest digit of 20.000 my of CH1 voltage, to the first decimal place. Here, the swipe input of a predetermined threshold length or more has been determined twice in succession. Thereby, the process of changing the target digit to the adjacent digit to the left has been performed twice. The transition from the screen 410 to the screen 420 is made through this process. In other words, in the transition from the screen 410 to the screen 420, the operations in step S3, step S4, step S7, and step S9 described above have been performed twice.

Next, in the screen 430, swipe input is determined to be in the leftward direction, and the digit to be operated is changed to a target digit 432. Specifically, the target digit is changed from the first decimal place to the tens place of 20.000 my of CH1 voltage. Here, the swipe input of the predetermined threshold length or more has been determined twice in succession. Thereby, the process of changing the target digit to the adjacent digit to the left has been performed twice. The transition from the screen 420 to the screen 430 is made through this process. In other words, in the transition from the screen 420 to the screen 430, the operations in step S3, step S4, step S7, and step S9 described above have been performed twice.

With reference to FIG. 6, an example of the updated display when the direction of the swipe input is the leftward direction and subsequently the downward direction is illustrated. Here, a screen is updated and displayed in the order of a screen 510, a screen 520, a screen 530, and a screen 540. In the screen 510, a touch operation within a predetermined area pertaining to a numerical object 511 is detected, and the display of a target digit 512 in the numerical object 511 is emphasized.

Next, in the screen 520, swipe input is determined to be in the leftward direction, and the digit to be operated is changed to a target digit 522. Specifically, the target digit is changed from the third decimal place, which is the smallest digit of 20.000 my of CH1 voltage, to the ones place. Here, the swipe input of the predetermined threshold length or more has been determined three times in succession. Thereby, the process of changing the target digit to the adjacent digit to the left has been performed three times. The transition from the screen 510 to the screen 520 is made through this process. In other words, in the transition from the screen 510 to the screen 520, the operations in step S3, step S4, step S7, and step S9 described above have been performed three times.

Next, in the screen 530, swipe input is determined to be in the downward direction, and a numerical value is decreasing with respect to a target digit 532 in a numerical object 531. Specifically, the voltage of CH1 is decreasing from 20.000 mv, which is a value in the screen 520, to 19.000 mv. Note that here, the swipe input of the predetermined threshold length has been determined once. Thereby, the operation of subtracting the numerical value of the target digit by 1 has been performed once. The transition from the screen 520 to the screen 530 is made through this process. In other words, in the transition from the screen 520 to the screen 530, the operations in step S3, step S4, step S6, and step S9 described above have been performed once.

Next, in the screen 540, swipe input is determined to be in the downward direction, and the numerical value is decreasing with respect to a target digit 542 in a numerical object 541. Specifically, the voltage of CH1 is decreasing from 19.000 mv, which is the value in the screen 530, to 16.000 mv. Note that here, the swipe input of the predetermined threshold length has been determined three times. Thereby, the operation of subtracting the numerical value of the target digit by 1 has been performed three times. The transition from the screen 530 to the screen 540 is made through this process. In other words, in the transition from the screen 530 to the screen 540, the operations in step S3, step S4, step S6, and step S9 described above have been performed three times.

Step S10: When the touch has not moved in step S3, the controller 11 determines whether the touch has left. When the touch has left, the process ends. When the touch has left, the controller 11 may perform the operation of determining the change of the numerical value in the numerical object. Alternatively, the controller 11 may perform the operation of displaying a dialog or the like to confirm the change of the numerical value in the numerical object. On the other hand, when the touch has not left, the process returns to step S3.

As described above, according to this embodiment, the information processing apparatus 10 determines the direction of the swipe input and, in response to the direction of the swipe input, changes the numerical value with respect to the target digit or changes the target digit. Therefore, the information processing apparatus 10 according to this embodiment can improve user interface technology for numerical input on touch screens in that the information processing apparatus 10 can accept numerical input without using a numeric keypad or the like for the numerical input. The technology of this embodiment is particularly useful when a plurality of numerical objects to be operated is displayed on a screen.

Although the present disclosure has been described based on the drawings and examples, it should be noted that one skilled in the art can easily make various variations and modifications based on the present disclosure. Therefore, it should be noted that these variations and modifications are included in the scope of the present disclosure. For example, the functions and the like included in each means, each step, or the like can be rearranged so as not to be logically inconsistent, and a plurality of means, steps, or the like can be combined into one or divided.

### (Variation 1)

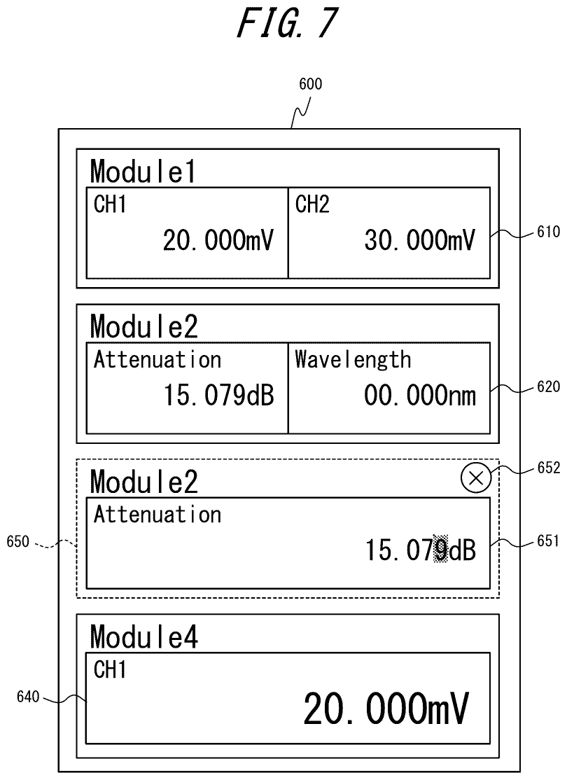

For example, the controller 11 may display a pop-up window that includes the numerical object to be operated. FIG. 7 illustrates an example of pop-up display. In FIG. 7, a pop-up window 650 is further displayed on the screen 600 in FIG. 2. The pop-up window 650 includes a numerical object 651 corresponding to the numerical object 620 (in this case, Attenuation in Module 2). The numerical object 651 and the numerical object 620 have the same contents, and by operating the numerical object 651, the numerical object 620 is changed. As illustrated in FIG. 7, the pop-up window may include a cancel button 652. The user can cancel the pop-up display by tapping the cancel button 652.

The pop-up window 650 is preferably displayed at approximately the center of the screen. For example, when a numerical object (in this case, the numerical object 610 or the numerical object 620) in the upper half of the screen 600 is selected as a target of operation by a tap or the like by the user, the pop-up window 650 is displayed, in the lower half of the screen 600, at a position adjacent to the upper half (in this case, the display position of the numerical object 630). When a numerical object (the numerical object 630 or the numerical object 640 in FIG. 2) in the lower half of the screen 600 is selected as a target of operation by a tap or the like by the user, the pop-up window is displayed, in the upper half of the screen 600, at a position adjacent to the lower half (in this case, the display position of the numerical object 620).

The numerical object 651 in the pop-up window 650 may be operated by the same operations as in the flowchart illustrated in FIG. 3. That is, the user first selects, by tapping or the like, a numerical object to be operated. After the selection, the user removes his/her finger. The user then performs a tap and a swipe operation on the numerical object (in this case, the numerical object 651) in the pop-up window again, in order to change a numerical value with respect to a target digit or change the target digit in the numerical object displayed in the pop-up window. By displaying the pop-up window and letting the user operate the numerical object in the pop-up window, the user can more easily grasp the numerical object to be operated. Also, by setting the numerical object in the pop-up window as the target of operation, sufficient space for the swipe operation can be secured. In particular, in this variation, the pop-up window is displayed, in the lower half of the screen, at the position adjacent to the upper half or, in the upper half of the screen, at the position adjacent to the lower half of the screen, which provides sufficient space for the swipe operation. In other words, in this variation, the numerical object to be operated is displayed in the pop-up window, and the pop-up window is displayed at approximately the center of the screen, which provides sufficient space for the swipe operation. This reduces stress on the user during input due to narrowness of an operation area.

### (Variation 2)

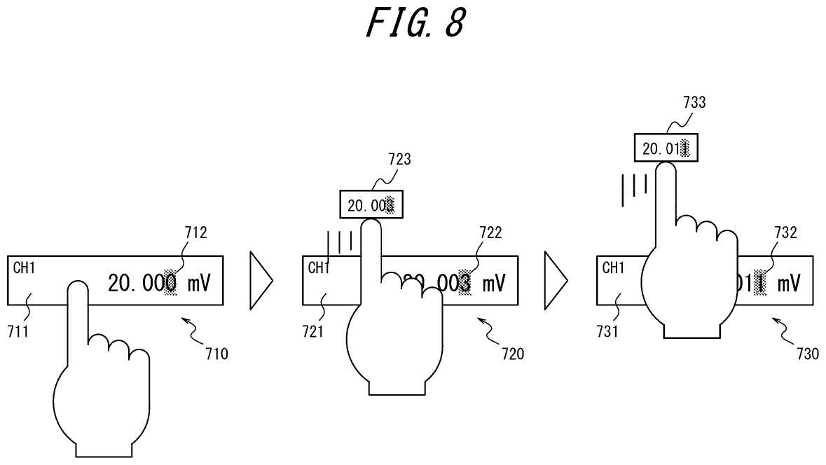

For example, the controller 11 may display the content or the like of the numerical object to be operated in a pop-up window that follows the finger. FIG. 8 illustrates an example of display when the pop-up window is added.

With reference to FIG. 8, an example of a variation of updated display when the direction of the swipe input is the upward direction is illustrated. Here, a screen is updated and displayed in the order of a screen 710, a screen 720, and a screen 730. On the screen 710, a touch operation within a predetermined area pertaining to a numerical object 711 is detected, and the display of a target digit 712 in the numerical object 711 is emphasized.

Next, in the screen 720, the swipe input is determined to be in the upward direction, and a numerical value is increasing with respect to a target digit 722 in a numerical object 721. Specifically, the voltage of CH1 is increasing from 20.000 mv, which is a value in the screen 710, to 20.003 mv. Note that here, the swipe input of the predetermined threshold length has been determined three times in succession. Thereby, the numerical value of the target digit has been added by 1 three times. The transition from the screen 710 to the screen 720 is made through this process. In other words, in the transition from the screen 710 to the screen 720, the operations in step S3, step S4, step S5, and step S9 described above have been performed three times. Furthermore, on the screen 720, a pop-up window 723 is displayed. The pop-up window 723 includes information on the numerical value corresponding to the numerical object. The pop-up window 723 is displayed in the vicinity of the touch position. The pop-up window 723 may be translucent. In other words, the pop-up window 723 may be displayed so that information behind the pop-up window 723 is visible.

Next, in the screen 730, swipe input is further determined to be in the upward direction, and the numerical value is increasing with respect to a target digit 732 in a numerical object 731. Specifically, the voltage of CH1 is increasing from 20.003 mv, which is the value in the screen 720, to 20.011 mv. Note that here, the swipe input of the predetermined threshold length or more has been determined eight times in succession. Thereby, the numerical value of the target digit has been increased by 1 eight times. The transition from the screen 720 to the screen 730 is made through this process. In other words, in the transition from the screen 720 to the screen 730, the operations in step S3, step S4, step S5, and step S9 described above have been performed eight times. Furthermore, on the screen 730, a pop-up window 733 is displayed in the same manner as on the screen 720. The pop-up window 733 includes information on the numerical value corresponding to the numerical object. The pop-up window 733 is displayed in the vicinity of the touch position. By displaying the pop-up windows 723 and 733 as described above, the user can easily grasp the content of the numerical value even when the numerical object to be operated is hidden by his/her hand, for example. The pop-up window may be displayed based on the position of the touch operation. For example, the pop-up window may be displayed only when the position of the touch operation is within a predetermined range from the target digit in the numerical object. This allows the pop-up window to be displayed only when the numerical object to be operated is likely to be hidden by the hand.

### (Variation 3)

For example, at an upper or lower end portion of the touch screen 13, the controller 11 may use a duration of the touch operation (hereinafter also referred to as a touch duration) at the upper or lower end portion, as a substitute for the swipe input. Specifically, when the touch operation has continued for a predetermined time at the upper end portion of the touch screen 13, the controller 11 may increase the numerical value with respect to the target digit based on the touch duration at the upper end portion after a lapse of the predetermined time. In other words, when the operation position with the finger at the upper end portion of the touch screen 13 has continued for the predetermined time without changing, the controller 11 may increase the numerical value with respect to the target digit, based on the touch duration at the upper end portion of the touch screen 13 after the lapse of the predetermined time. The predetermined time may be, for example, 1 second. For example, the controller 11 may increase the numerical value by 1 every time the touch duration elapses a predetermined threshold (e.g., 0.5 seconds). Thereby, the operation to increase the numerical value can be performed even when the swipe operation in the upward direction is not possible at the upper end portion of the touch screen 13. This also reduces stress on the user during input due to narrowness of the operation area.

Similarly, when the touch operation has continued for the predetermined time at the lower end portion of the touch screen 13, the controller 11 may decrease the numerical value with respect to the target digit based on the touch duration at the lower end portion after a lapse of the predetermined time. For example, the controller 11 may decrease the numerical value by 1 every time the touch duration elapses the predetermined threshold. In other words, when the operation position with the finger at the lower end portion of the touch screen 13 has continued for the predetermined time without changing, the controller 11 may decrease the numerical value with respect to the target digit, based on the touch duration at the lower end portion of the touch screen 13 after the lapse of the predetermined time. Thereby, the operation to decrease the numerical value can be performed even when the swipe operation in the downward direction is not possible at the lower end portion of the touch screen 13. This also reduces stress on the user during input due to narrowness of the operation area.

Similarly, at a left or right end portion of the touch screen 13, the controller 11 may use a touch duration at the left or right end portion, as a substitute for the swipe input. Specifically, when the touch operation has continued for a predetermined time at the left end portion of the touch screen 13, the controller 11 may change the target digit to the adjacent digit to the left, based on the touch duration at the left end portion after a lapse of the predetermined time. In other words, when the operation position with the finger at the left end portion of the touch screen 13 has continued for the predetermined time without changing, the controller 11 may change the target digit to the adjacent digit to the left, based on the touch duration at the left end portion of the touch screen 13 after the lapse of the predetermined time. For example, the controller 11 may change the target digit to the adjacent digit to the left every time the touch duration elapses a predetermined threshold (e.g., 0.5 seconds). Thereby, the operation to change the target digit to the adjacent digit to the left can be performed even when the swipe operation in the leftward direction is not possible at the left end portion of the touch screen 13. This also reduces stress on the user during input due to narrowness of the operation area.

Similarly, when the touch operation has continued for the predetermined time at the right end portion of the touch screen 13, the controller 11 may change the target digit to the adjacent digit to the right, based on the touch duration at the right end portion after a lapse of the predetermined time. In other words, when the operation position with the finger at the right end portion of the touch screen 13 has continued for the predetermined time without changing, the controller 11 may change the target digit to the adjacent digit to the right based on the touch duration at the right end portion of the touch screen 13 after the lapse of the predetermined time. For example, the controller 11 may change the target digit to the adjacent digit to the right every time the touch duration elapses the predetermined threshold (e.g., 0.5 seconds). Thereby, the operation to change the target digit to the adjacent digit to the right can be performed even when the swipe operation in the rightward direction is not possible at the right end portion of the touch screen 13. This also reduces stress on the user during input due to narrowness of the operation area.

1. An information processing apparatus comprising:
a touch screen; and
a controller configured to:
detect a touch operation within a predetermined area on the touch screen;
upon detecting the touch operation, emphasize display of a predetermined digit, as a target digit, of a numeral value displayed in a numerical object; and
determine a direction of swipe input after the touch operation and, in response to the direction, change the numerical value with respect to the target digit or change the target digit.

2. The information processing apparatus according to claim 1, wherein the controller is configured to:
increase the numerical value with respect to the target digit when the direction is an upward direction,
decrease the numerical value with respect to the target digit when the direction is a downward direction,
change the target digit to an adjacent digit to left when the direction is a leftward direction, and
change the target digit to an adjacent digit to right when the direction is a rightward direction.

3. The information processing apparatus according to claim 1, wherein the emphasized display is an underline.

4. The information processing apparatus according to claim 1, wherein the emphasized display is inverted display.

5. The information processing apparatus according to claim 2, wherein the controller is further configured to:
when the touch operation has continued for a predetermined time at an upper end portion of the touch screen, increase the numerical value with respect to the target digit, based on a touch duration at the upper end portion after a lapse of the predetermined time, and
when the touch operation has continued for the predetermined time at a lower end portion of the touch screen, decrease the numerical value with respect to the target digit, based on a touch duration at the lower end portion after a lapse of the predetermined time.

6. The information processing apparatus according to claim 2, wherein the controller is further configured to:
when the touch operation has continued for a predetermined time at a left end portion of the touch screen, change the target digit to the adjacent digit to the left, based on a touch duration at the left end portion after a lapse of the predetermined time, and
when the touch operation has continued for the predetermined time at a right end portion of the touch screen, change the target digit to the adjacent digit to the right, based on a touch duration at the right end portion after a lapse of the predetermined time.

7. The information processing apparatus according to claim 1, wherein the controller is further configured to display a pop-up window corresponding to the numerical value.

8. The information processing apparatus according to claim 7, wherein the pop-up window is displayed translucently.

9. A method performed by an information processing apparatus including a touch screen, the method comprising:
detecting a touch operation within a predetermined area on the touch screen;
upon detecting the touch operation, emphasizing display of a predetermined digit, as a target digit, of a numeral value displayed in a numerical object; and
determining a direction of swipe input after the touch operation and, in response to the direction, changing the numerical value with respect to the target digit or changing the target digit.

10. A non-transitory computer readable medium storing a program configured to cause a computer to execute operations, the computer including a touch screen and functioning as an information processing apparatus, the operations comprising:
detecting a touch operation within a predetermined area on the touch screen;
upon detecting the touch operation, emphasizing display of a predetermined digit, as a target digit, of a numeral value displayed in a numerical object; and
determining a direction of swipe input after the touch operation and, in response to the direction, changing the numerical value with respect to the target digit or changing the target digit.
